(19) United States
(12) Patent Application Publication
(10) Pub. No.: US 2017/0133145 A1
(43) Pub. Date: May 11, 2017

(54) COIL COMPONENT AND METHOD OF MANUFACTURING THE SAME

(71) Applicant: SAMSUNG ELECTRO-MECHANICS CO., LTD., Suwon-si (KR)

(72) Inventors: Seok Il HONG, Suwon-si (KR); Jae Yeol CHOI, Suwon-si (KR); Jong Bong LIM, Suwon-si (KR); Ju Hwan YANG, Suwon-si (KR)

(21) Appl. No.: 15/200,666

(22) Filed: Jul. 1, 2016

(30) Foreign Application Priority Data
Nov. 9, 2015 (KR) 10-2015-0156523

(51) Int. Cl. H01F 27/28; H01F 41/04

(52) U.S. Cl. CPC H01F 27/2804; H01F 41/041; H01F 2027/2809

(57) ABSTRACT

A coil component includes a substrate and a coil part disposed on the substrate. The coil part includes an insulating layer having an opening, and one or more coil patterns disposed in the opening. The coil patterns include first seed layers disposed on a portion of a side surface and a portion of a bottom surface of an interior of the opening, a second seed layer disposed to cover the first seed layers, and a metal layer disposed on the second seed layer.

### CROSS-REFERENCE TO RELATED APPLICATION

This application claims the priority and benefit of Korean Patent Application No. 10-2015-0156523 filed on Nov. 9, 2015, with the Korean Intellectual Property Office, the disclosure of which is incorporated herein by reference.

### BACKGROUND

The present disclosure relates to a coil component and a method of manufacturing the same.

The transmission and reception of data within a high frequency band is commonly used in electronic devices such as digital TVs, mobile phones, notebook computers, and the like. It is expected that in the future, a frequency utilized by such information technology (IT) electronic devices for the transmission and reception of data will be relatively high due to the increasing complexity and multifunctionalization of such IT electronic devices. Such high frequency may be used in connecting the electronic IT devices via universal serial bus (USB) and other communications ports. For example, in order to rapidly perform data transmissions and receive data, a frequency band used by an electronic device may be moved from the megahertz (MHz) band to the higher gigahertz (GHz) frequency band to transmit and receive data through a larger number of internal signal lines.

Meanwhile, when the GHz band is used in order to transmit and receive a large amount of data between a main device and a peripheral device, a problem may occur in smoothly processing the data due to a delay in a signal and other noise. In order to solve this problem, a component for removing electromagnetic interference (EMI) can be provided around a connection of the IT electronic device and the peripheral device, and for example, a common mode filter (CMF), or the like may be used.

Meanwhile, in accordance with miniaturization and thinning of electronic devices, a coil component, such as those commonly used in common mode filters or the like, is also required to be thinned and miniaturized. However, thin film-type coil components (rather than winding-type coil components) generally do not satisfy the requirements for high frequency (e.g., GHz band) communication. As a result, in order to form a coil pattern of the thin film-type coil component according to the related art, a so-called semi-additive process (SAP) has been used in which a seed layer is formed on a substrate in advance, a photosensitive material for patterning is coated on the seed layer and developed thereon, copper plating is filled between patterns to form the coil pattern, and a photosensitive insulating material and the seed layer are then removed by flash etching, or the like.

Since the method described above uses photosensitive materials for both patterning and for insulation, manufacturing costs may be relatively high and productivity low. Further, in a case in which a lower layer is not planarized by a flash etching, or the like, in a process of forming a coil pattern in a multilayer body, a margin of a line width may be decreased. Further, a coil loss factor may be increased.

### SUMMARY

An aspect of the present disclosure may provide a coil component having excellent productivity, having a small coil loss factor, and improving resolution of a fine line width, and a method capable of efficiently manufacturing the same.

According to an aspect of the present disclosure, a coil component may include a substrate and a coil part disposed on the substrate. The coil part includes an insulating layer having an opening, and one or more coil patterns disposed in the opening. The one or more coil patterns include first seed layers disposed on a portion of a side surface and a portion of a bottom surface of an interior of the opening, a second seed layer disposed to cover the first seed layers, and a metal layer disposed on the second seed layer.

According to another aspect of the present disclosure, a coil component may include a substrate and a coil part disposed on the substrate. The coil part includes an insulating layer having an opening and one or more coil patterns disposed in the opening. Three or more layers each including copper are disposed on a portion of a side surface and a portion of a bottom surface of an interior of the opening.

According to a further aspect of the disclosure, a method may include forming an opening in an insulating layer disposed on a substrate, wherein the opening is formed in a pattern of one or more coils, and forming a coil part including one or more coil patterns in the opening formed in the insulating layer. The forming of the coil part includes forming first seed layers on a portion of a side surface and a portion of a bottom surface of an interior of the opening, forming a second seed layer to cover the first seed layers, and forming a metal layer on the second seed layer.

### BRIEF DESCRIPTION OF DRAWINGS

The above and other aspects, features, and other advantages of the present disclosure will be more clearly understood from the following detailed description taken in conjunction with the accompanying drawings, in which:

FIG. 1 is a schematic perspective view illustrating an example of a coil component;

FIG. 2 is a schematic cross-sectional view taken along a surface I-I′ of the coil component of FIG. 1;

FIG. 3 is a schematic enlarged view of a region S of the coil component of FIG. 2; and

FIGS. 4A through 4D show illustrative steps of a process for manufacturing the coil component.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region, or wafer (substrate), is referred to as being “on, ” “connected to, ” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers, and/or sections, these members, components, regions, layers, and/or sections should not be limited by these terms. These terms are only used to distinguish one member, component, region, layer, or section from another member, component, region, layer, or section. Thus, a first member, component, region, layer, or section discussed below could be termed a second member, component, region, layer, or section without departing from the teachings of the exemplary embodiments.

Spatially relative terms, such as “above,” “upper,” “below,” “lower,” and the like, may be used herein for ease of description to describe one element's positional relationship relative to one or more other elements as shown in the figures. It will be understood that the spatially relative terms are intended to encompass different orientations of the device in use or operation in addition to the orientation depicted in the figures. For example, if the device in the figures is turned over, elements described as “above” or “upper” relative to other elements would then be oriented “below” or “lower” relative to the other elements or features. Thus, the term “above” can encompass both the above and below orientations depending on a particular direction of the devices, elements, or figures. The device may be otherwise oriented (rotated 90 degrees or at other orientations) and the spatially relative descriptors used herein may be interpreted accordingly.

The terminology used herein is for describing particular illustrative embodiments only and is not intended to be limiting of the present disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, members, elements, and/or groups, but do not preclude the presence or addition of one or more other features, integers, steps, operations, members, elements, and/or groups.

Hereinafter, embodiments of the present disclosure will be described with reference to schematic views illustrating embodiments. In the drawings, components having ideal shapes are shown. However, variations from these ideal shapes, for example due to variability in manufacturing techniques and/or tolerances, also fall within the scope of the disclosure. Thus, embodiments of the present disclosure should not be construed as being limited to the particular shapes of regions shown herein, but should more generally be understood to include changes in shape resulting from manufacturing methods and processes. The following embodiments may also be constituted by one or a combination thereof.

The present disclosure describes a variety of configurations, and only illustrative configurations are shown herein. However, the disclosure is not limited to the particular illustrative configurations presented herein, but extends to other similar/analogous configurations as well.

Coil Component

Hereinafter, a coil component will be described. For convenience of explanation, the coil component will be described as a common mode filter, but is not limited thereto and can be used in a wide range of other applications. More generally, the contents of the present disclosure may be applied to coil components for various other purposes.

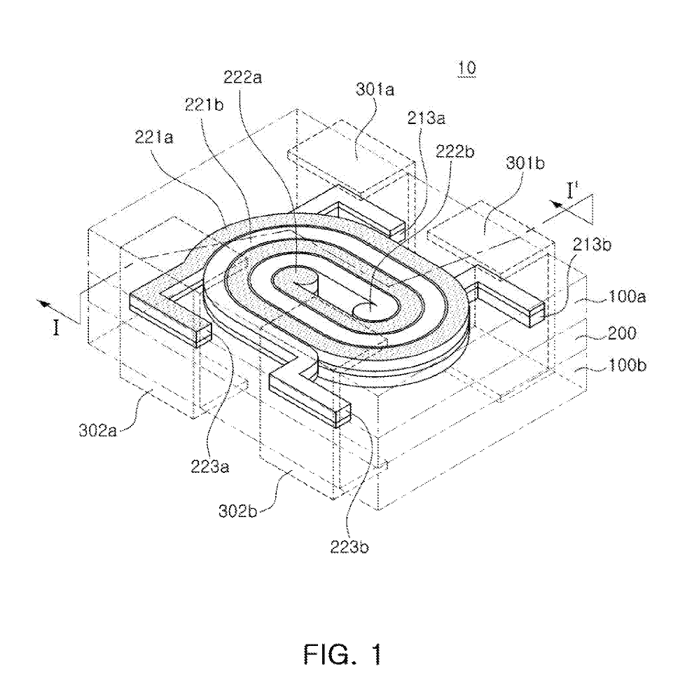

FIG. 1 is a schematic perspective view illustrating an example of a coil component.

Referring to FIG. 1, a coil component 10 according to an example may include a coil part 200, cover parts 100a and 100b disposed on upper and lower portions of the coil part 200, and external electrodes 301a, 301b, 302a, and 302b each of which has at least a portion is disposed on the cover parts 100a and 100b. Here, the upper portion refers to a direction away from a mounting substrate used in a manufacturing process as described below, and the lower portion refers to a direction toward the mounting substrate used in the manufacturing process described below. In this case, when a target component is referred to as being disposed on the upper portion or the lower portion, it can be directly in contact with the upper portion or the lower portion of a reference component, or it may be disposed in the corresponding upper/lower portion direction without necessarily directly contacting the reference component.

The cover parts 100a and 100b may serve as a passage for magnetic flux generated by the coil part 200, and may include a magnetic material therein for this purpose.

Further, the cover parts 100a and 100b may serve to support the external electrodes 301a, 301b, 302a, and 302b and/or to mechanically and electrically protect the coil part 200.

Further, the cover parts 100a and 100b may also provide a mounting surface when the coil component 10 is mounted on various electronic devices.

The cover parts 100a and 100b may be sheet-type cover parts, and in this case, since the cover parts 100a and 100b may be simply formed by pressing and stacking sheet-type magnetic materials, process productivity may be improved.

The cover parts 100a and 100b may include a first cover part 100a disposed on the upper portion of the coil part 200 and a second cover part 100b disposed on the lower portion of the coil part 200.

The magnetic material included in the cover parts 100a and 100b may be used without being particularly limited as long as it has magnetic characteristics.

For example, the magnetic material may include one or more selected from the group consisting of metallic magnetic powder particles and ferrites, but is not necessarily limited thereto.

The metallic magnetic powder may be, for example, a crystalline or amorphous metal including one or more selected from the group consisting of iron (Fe), silicon (Si), chromium (Cr), aluminum (Al), and nickel (Ni), but is not limited thereto.

The ferrite may be, for example, a Fe—Ni—Zn based ferrite, a Fe—Ni—Zn—Cu based ferrite, a Mn—Zn based ferrite, a Ni—Zn based ferrite, a Zn—Cu based ferrite, a Ni—Zn—Cu based ferrite, a Mn—Mg based ferrite, a Ba based ferrite, a Li based ferrite, or the like, but is not limited thereto.

The coil part 200 may serve to perform various functions in the electronic device using characteristics revealed from a coil of the coil component 10.

In the coil component 10 according to an example, the coil part 200 may be of a so called thin film-type, which is distinguished from a winding-type having a structure in which a wire is wound around a magnetic core.

A detail description of the coil part 200 will be described below.

The external electrodes 301a, 301b, 302a, and 302b may serve to connect the coil component 10 to the electronic device.

In the coil component 10 according to an example, at least a portion of each of the external electrodes 301a, 301b, 302a, and 302b may be disposed on the first and second cover parts 100a and 100b.

As such, as at least portions of each of the external electrodes 301a, 301b, 302a, and 302b are disposed on both of the first and second cover parts 100a and 100b, both of the first and second cover parts 100a and 100b may provide the mounting surface supporting the external electrodes 301a, 301b, 302a, and 302b.

Therefore, since there is no influence on a direction when the coil component 10 is mounted on the electronic device, a process may be more simplified.

The external electrodes 301a, 301b, 302a, and 302b may be referenced as first to fourth external electrodes 301a, 301b, 302a, and 302b, respectively, and may respectively be connected to first to fourth coil patterns 211a, 211b, 221a, and 221b of the coil part 200 to be described below.

Further, the external electrodes may each have a shape of ‘ [symbol] ’ as shown in FIG. 1. However, the shape of the external electrodes is not limited thereto, and the external electrodes 301a, 301b, 302a, and 302b may be implemented in various different shapes.

As a material of the external electrodes 301a, 301b, 302a, and 302b, any material may be used without being particularly limited, as long as it may provide electrical conductivity.

For example, the external electrodes 301a, 301b, 302a, and 302b may include one or more selected from the group consisting of gold (Au), silver (Ag), platinum (Pt), copper (Cu), nickel (Ni), palladium (Pd), and alloys thereof, but is not limited thereto.

Meanwhile, gold (Au), silver (Ag), platinum (Pt), and palladium (Pd) have an advantage in that they are stable, but they are high in price, while copper (Cu) and nickel (Ni) have a disadvantage in that they may be oxidized during a sintering and may therefore deteriorate electrical conductivity, but they are low in price.

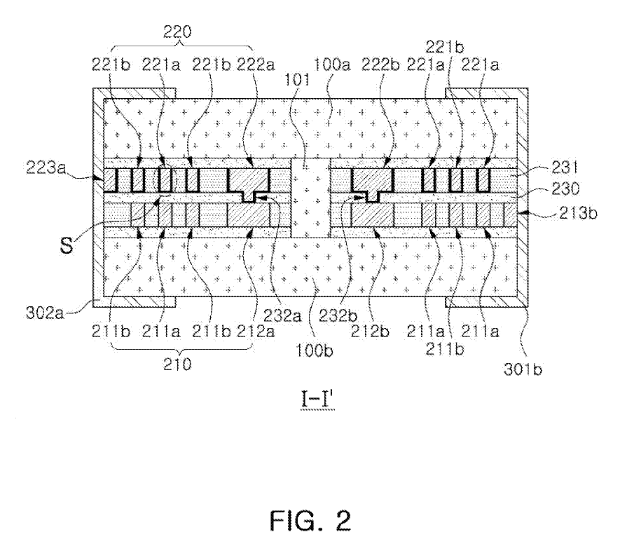

FIG. 2 is a schematic cross-sectional view taken along a surface I-I′ of the coil component of FIG. 1.

Referring to FIG. 2, the coil part 200 of the coil component 10 according to an example may include coil patterns 210 and 220, a substrate 230 disposed between the coil patterns 210 and 220, and an insulating layer 231 having an opening (e.g., at 101) and disposed between windings of the coil patterns 210 and 220.

Further, an insulating layer may be further disposed on an upper portion and a lower portion of the coil patterns 210 and 220.

Each of the coil patterns 210 and 220 may have a double coil in which two coil patterns 211a and 211b, or 221a and 221b, that are formed on substantially the same plane. Alternatively, each of the coil patterns may also be implemented in a single coil having multilayer form. Meanwhile, in the case in which each of the coil patterns is a double coil, since a process of manufacturing the coil patterns is simple, costs for manufacturing the coil patterns may be reduced.

The coil patterns 210 and 220 may have first and second coil patterns 211a and 211b on substantially one same plane. Further, the coil patterns 210 and 220 may have third and fourth coil patterns 221a and 221b on substantially another same plane.

However, although only the two coil patterns 210 and 220 are illustrated in the drawing, the coil patterns may be configured as two or more layers according to desired specifications, and for example, a third coil pattern and a fourth coil pattern may be further stacked.

The first coil pattern 211a may be electrically connected to the third coil pattern 221a through a first via pattern 232a.

Thereby, a first single coil configured by a series circuit connection of the two coils 211a and 221a may be provided.

The second coil pattern 211b may be electrically connected to the fourth coil pattern 221b through a second via pattern 232b.

Thereby, a second single coil configured by a series circuit connection of the two coils 211b and 221b may be provided.

In this case, the coil component may be operated as a common mode filter in which if a current flows in the same direction between the first and second single coils, magnetic fluxes may be mixed and common mode impedance may be increased to thereby suppress common mode noise, and if a current flows in opposite directions between the first and second single coils, the magnetic fluxes are offset by each other and differential mode impedance is decreased to thereby transmit a desired transmission signal.

The coil part 200 of the coil component 10 may include first and second via connection patterns 212a and 212b and third and fourth via connection patterns 222a and 222b which are directly connected to the via patterns 232a and 232b.

Here, the first and second via connection patterns 212a and 212b and the third and fourth via connection patterns 222a and 222b respectively are end portions of the first and second coil patterns 211a and 211b and the third and fourth coil patterns 221a and 221b, and are directly vertically connected to the via patterns 232a and 232b.

Referring to FIGS. 1 and 2, the coil pattern 210 disposed on a lower portion of the substrate 230 may include first and second lead terminals 213a and 213b connected to the external electrodes 301a and 301b.

Here, the first and second lead terminals 213a and 213b may be respectively connected to the first and second external electrodes 301a and 301b.

The coil pattern 220 disposed on an upper portion of the substrate 230 may include third and fourth lead terminals 223a and 223b connected to the external electrodes 302a and 302b.

Here, the third and fourth lead terminals 223a and 223b may be respectively connected to the third and fourth external electrodes 302a and 302b.

Thereby, the coil part 200 may be electrically connected to the external electrodes 301a, 301b, 302a, and 302b.

However, the shape of the lead terminals 213a and 213b is not limited to the shape illustrated in the drawings, and various alternative shapes may be used.

The substrate 230 may electrically insulate the coil patterns 211a, 211b, 221a, and 221b formed on different layers.

Here, the via patterns 232a and 232b may be formed on the substrate 230, and as a result, the coil patterns 211a, 211b, 221a, and 221b formed on the different layers may be electrically connected to each other.

For example, in an example, the substrate 230 may include a first via pattern 232a connecting the first coil pattern 211a and the third coil pattern 221a, and a second via pattern 232b connecting the second coil pattern 211b and the fourth coil pattern 221b.

A material of the substrate 230 is not particularly limited, and a resin having a reinforcement material such as a glass fiber or an inorganic filler impregnated therein, for example, a prepreg, may be used. In addition, a thermosetting resin, a photo-curable resin, and/or the like, may be also used and an Ajinomoto build-up film may also be used, but the present disclosure is not limited thereto.

The substrate 230 may exist in an attached form due to characteristics of the material thereof.

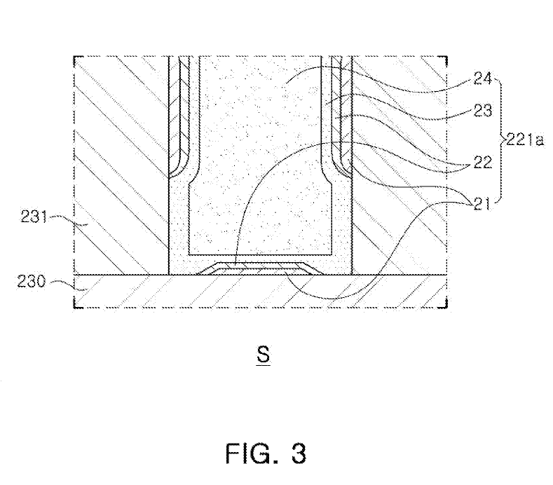

FIG. 3 is a schematic enlarged view of a region S of the coil component of FIG. 2.

Referring to FIG. 3, the coil part 200 may include the insulating layer 231 having the opening and the coil pattern 221a disposed in the opening of the insulating layer 231. The coil pattern 221a may include first seed layers 21 and 22 disposed on a portion of a side surface and a portion of a bottom surface of an interior of the opening, a second seed layer 23 disposed to cover the first seed layers 21 and 22, and a metal layer 24 disposed on the second seed layer 23.

In general, in order to implement a high aspect ratio (A/R), the opening of the insulating layer needs to have a thick thickness (e.g., where the thickness can be measured orthogonally to a surface of the substrate 230).

In this case, in order to uniformly form the seed layers in the opening, relatively expensive equipment may be required.

On the other hand, in a case in which existing sputtering equipment is used, it may be difficult to implement uniform deposition at the time of forming the seed layers in the opening in order to implement the high aspect ratio (A/R). As a result, regions on which the seed layers are not formed may occur in portions of the bottom surface and the side surface of the opening.

As such, in the case in which the regions on which the seed layers are not formed occur in the portions of the bottom surface and the side surface of the opening, a non-formation part of an electroplating layer to be described below may occur, thereby causing a problem in which performance of the coil component is deteriorated.

According to an exemplary embodiment presented herein, since the coil pattern 221a includes the first seed layers 21 and 22 disposed on the portion of the side surface and the portion of the bottom surface of the interior of the opening of the insulating layer 231, the second seed layer 23 disposed to cover the first seed layers 21 and 22, and the metal layer 24 disposed on the second seed layer 23, the non-formation part of the metal layer 24 does not occur and there is no problem that performance of the coil component is deteriorated.

The insulating layer 231 may serve to provide insulation property to the coil patterns 211a, 211b, 221a, and 221b, the via connection patterns 212a, 212b, 222a, and 222b, the lead terminals 213a, 213b, 223a, and 223b, and the like, and to protect the coil patterns 211a, 211b, 221a, and 221b, the via connection patterns 212a, 212b, 222a, and 222b, the lead terminals 213a, 213b, 223a, and 223b, and the like from impact, moisture, high temperature, or the like, at the same time.

Therefore, as a material of the insulating layer, a photosensitive resin having easy machinability, or the like, may be appropriately selected by taking account of insulation, heat resistance, humidity resistance, and the like.

For example, the insulating layer 231 may be a known positive or negative-type dry film, but is not limited thereto.

The insulating layer 231 may also contain a ferrite of high permeability, as needed.

The ferrite may have a powder form. For example, as the ferrite, a Fe—Ni—Zn oxidation based powder, a Fe—Ni—Zn—Cu oxidation based powder, and the like may be used as a soft magnetic substance. In addition thereto, a metallic based powder such as Fe, Ni, Fe—Ni (permalloy), or the like, or a mixture thereof may be used.

The above-mentioned ferrite powder may be contained to be diffused between wires such as the coil patterns 211a, 211b, 221a, and 221b, the via connection patterns 212a, 212b, 222a, and 222b, the lead terminals 213a, 213b, 223a, and 223b, and the like. As a result, the insulating layer 231 may have high permeability and may act as a passage of a magnetic flux loop.

As a result, the magnetic loop occurring from the coil patterns 211a, 211b, 221a, and 221b, the via connection patterns 212a, 212b, 222a, and 222b, the lead terminals 213a, 213b, 223a, and 223b, and the like may flow more smoothly, and impedance characteristics may be increased.

The opening of the insulating layer 231 may be formed by directly patterning the insulating layer 231. As a result, a separate photosensitive material for pattern is not required unlike the related art, and the number of processes may also be simplified.

In addition, in a case in which the coil patterns are formed by a semi-additive process or the like, the number of processes may be large and there may be a limit in implementing a pattern having a desired shape because an upper portion of a plating pattern may be influenced by a flash etching process used for removing the seed layers after a photoresist is removed and a portion of the seed layers is irregularly removed.

On the other hand, in a case in which the opening is formed by patterning the insulating layer 231 in a thickness direction thereof using exposure and development as in an example, and the plating pattern is subsequently formed, the above-mentioned problem does not occur.

Further, since the opening is formed by directly patterning the insulating layer, the formed coil pattern may have an aspect ratio higher than that of the related art.

The first seed layers 21 and 22 may be a multilayer structure including a buffer seed layer 21 including one or more selected from the group consisting of chromium (Cr), molybdenum (Mo), tungsten (W), tantalum (Ta), palladium (Pd), nickel (Ni), and alloys thereof, and a plating seed layer 22 formed on the buffer seed layer and including one or more selected from the group consisting of gold (Au), silver (Ag), platinum (Pt), copper (Cu), nickel (Ni), palladium (Pd), and alloys thereof.

For example, the first seed layers may be a double layer structure of a layer of one or more of titanium (Ti), molybdenum (Mo), tungsten (W), and tantalum (Ta), and a layer formed of copper (Cu).

The buffer seed layer 21 may serve to secure adhesion to the insulating layer 231, and the plating seed layer 22 may serve as a basic plating layer for easily forming the second seed layer 23.

The second seed layer 23 may be formed by electroless plating, but is not necessarily limited thereto.

The second seed layer 23 may be disposed to cover the entirety of the side surface and the bottom surface of the interior of the opening of the insulating layer 231.

The second seed layer 23 is provided to easily form the metal layer 24 to be described below. As a material of the second seed layer 23, any material may be used without being particularly limited, as long as it is a metal capable of providing electrical conductivity.

For example, the material of the second seed layer 23 may include one or more selected from the group consisting of gold (Au), silver (Ag), platinum (Pt), copper (Cu), nickel (Ni), palladium (Pd), and alloys thereof.

According to an exemplary embodiment, the first seed layers 21 and 22 are disposed on the portion of the side surface and the portion of the bottom surface of the interior of the opening of the insulating layer 231, and the second seed layer 23 is disposed to cover the first seed layers 21 and 22, where the second seed layer 23 may be disposed to cover the entirety of the side surface and the bottom surface of the interior of the opening of the insulating layer 231.

The first seed layers 21 and 22 and the second seed layer 23 are disposed as described above, such that the metal layer 24 may be disposed without leaving any regions in which the metal layer 24 is not formed within the opening of the insulating layer 231.

As a result, the coil component according to an exemplary embodiment does not have the problem that performance thereof is deteriorated.

The metal layer 24 may be a main material forming the coil patterns 211a, 211b, 221a, and 221b, the via connection patterns 212a, 212b, 222a, and 222b, the lead terminals 213a, 213b, 223a, and 223b, and the like. Any metal may be used without being particularly limited, as long as it provides electrical conductivity.

For example, the material of the metal layer 24 may include one or more selected from the group consisting of gold (Au), silver (Ag), platinum (Pt), copper (Cu), nickel (Ni), palladium (Pd), and alloys thereof.

According to an exemplary embodiment, the coil patterns 211a, 211b, 221a, and 221b may be configured as layers including three or more layers of copper (Cu).

That is, since the plating seed layer 22 may be formed of copper (Cu) as the first seed layer, the second seed layer 23, which is an electroless plating layer, may also be formed of copper (Cu), and the metal layer 24 disposed on the second seed layer 23 may include copper (Cu) by an electroplating method, the coil patterns 211a, 211b, 221a, and 221b may be configured by the layers including three or more layers of copper (Cu).

According to an exemplary embodiment, after the first seed layers 21 and 22, the second seed layer 23, and the metal layer 24 are formed, the insulating layer 231 may be flattened by a flattening process. Thereby, a process of removing the first seed layers 21 and 22 may be unnecessary.

Therefore, an influence of the flash etching on a top surface of the metal layer 24 may be prevented.

Further, according to an exemplary embodiment, the opening may be formed by directly patterning the insulating layer 231. As a result, a separate photosensitive material is not required for patterning, unlike in the case of the related art, and the number of processes may also be simplified.

Further, similarly, the opening can be formed by patterning the insulating layer 231 in the thickness direction thereof using exposure and development, and the plating pattern is subsequently formed, such that the problem occurring from an SAP method according to the related art does not occur.

According to an exemplary embodiment, since the coil patterns 211a, 211b, 221a, and 221b include the first seed layers 21 and 22 disposed on the portion of the side surface and the portion of the bottom surface of the interior of the opening of the insulating layer 231, the second seed layer 23 disposed to cover the first seed layers 21 and 22, and the metal layer 24 disposed on the second seed layer 23, the high aspect ratio (A/R) may be implemented to improve chip performance, and uniform seed layers may be implemented in the opening of the insulating layer even though an existing facility is used.

According to another exemplary embodiment, a coil component 10 may include a substrate 230 and a coil part 200 disposed on the substrate 230, wherein the coil part 200 may include an insulating layer 231 having an opening, and coil patterns 210 and 220 disposed in the opening of the insulating layer 231, and layers including three or more layers of copper may be disposed on a portion of a side surface and a portion of a bottom surface of an interior of the opening.

An electroless plating layer may be disposed on the side surface and the bottom surface of the interior of the opening, and an electroplating layer may be disposed on the electroless plating layer.

The electroless plating layer may include copper (Cu).

The coil patterns 210 and 220 may include the first seed layers 21 and 22 disposed on the portion of the side surface and the portion of the bottom surface of the interior of the opening, the second seed layer 23 disposed to cover the first seed layers 21 and 22, and the metal layer 24 disposed on the second seed layer 23.

The first seed layers 21 and 22 may be disposed in a plurality of layers, and may be configured of a layer including titanium (Ti) and a layer including copper (Cu) disposed on the layer including titanium (Ti).

A region in which the different number of layers including copper (Cu) is disposed may exist on an exposed part of the substrate 230 (e.g., a part of the substrate 230 exposed through the opening in the insulating layer 231), which is the bottom surface of the opening.

That is, since the first seed layers 21 and 22 may be disposed on some regions of the exposed part of the substrate 230, which is the bottom surface of the opening, and the first seed layers 21 and 22 may not be disposed on other regions of the exposed part of the substrate 230, different regions of the opening may have different numbers of layers including copper in a final structure of the coil component.

In order to avoid overlapped descriptions, a detailed description of features of the coil component according to another exemplary embodiment that are the same as those of the coil component according to the exemplary embodiment described above will be omitted.

Method of Manufacturing Coil Component

Hereinafter, a method of manufacturing a coil component will be described. For convenience of explanation, the method of manufacturing a coil component will be described as a method of manufacturing a common mode filter, but is not limited thereto. The contents of the present disclosure may be applied to a method of manufacturing a coil component used for various other purposes as well.

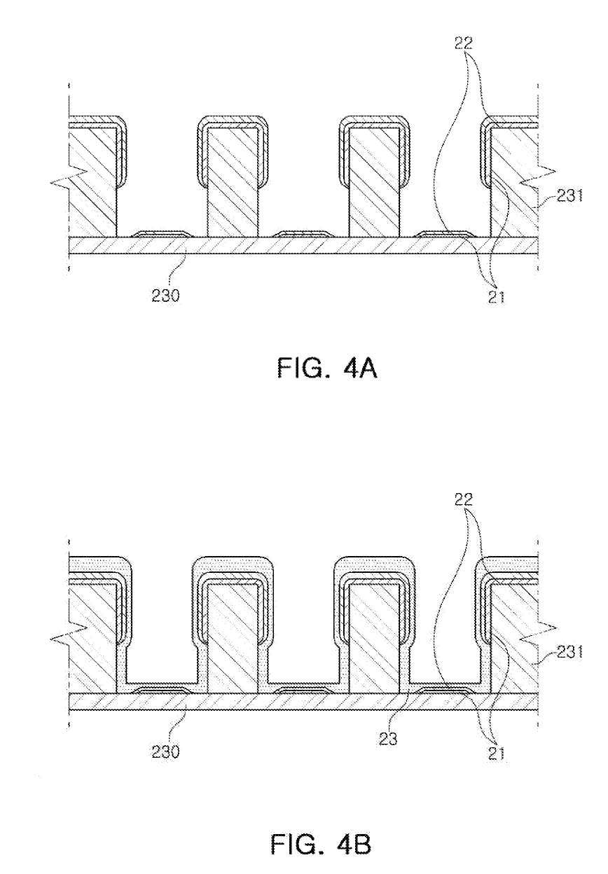

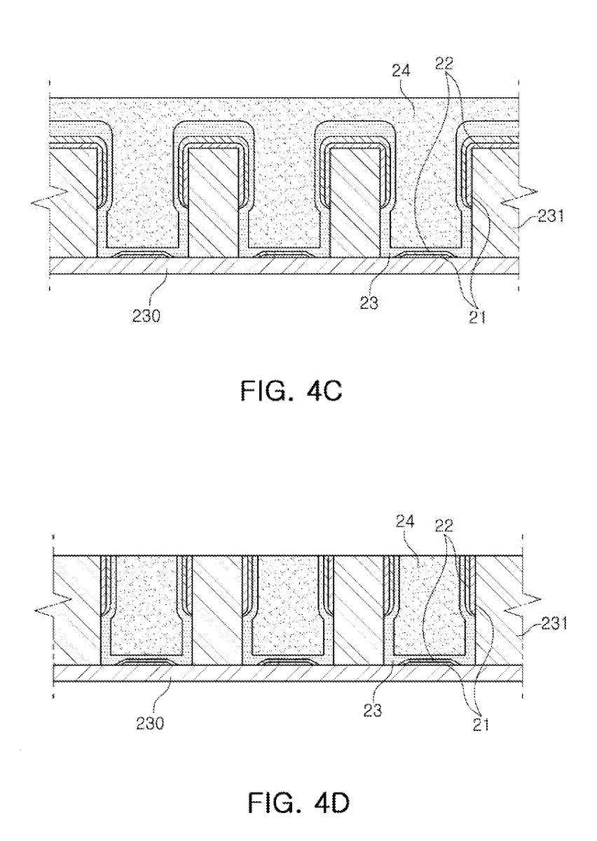

FIGS. 4A through 4D show illustrative steps of a manufacturing process of the coil component.

Contents overlapped with the above description will be omitted from the description of the manufacturing method below in order to avoid duplication, and reference should be made to the above description in interpreting the manufacturing of the coil component as described below.

Referring to FIG. 4A, a substrate 230 on which a metal layer 24 (shown in FIG. 4D) is to be disposed on at least one surface thereof may be prepared.

For example, the substrate 230 on which the metal layer 24 is to be disposed may be a copper clad laminate (CCL) which is generally used in a field of a printed circuit board.

A material of the substrate 230 is not particularly limited, and a resin having a reinforcement material such as a glass fiber or an inorganic filler impregnated therein, for example a prepreg, may be used. In addition, a thermosetting resin, a photo-setting resin, and/or the like, may be also used and an Ajinomoto build-up film may also be used, but the present disclosure is not limited thereto.

A material of the metal layer is also not particularly limited, and may include one or more selected from the group consisting of gold (Au), silver (Ag), platinum (Pt), copper (Cu), nickel (Ni), palladium (Pd), and alloys thereof, but is not limited thereto.

Next, an insulating layer 231 may be formed on the metal layer of the substrate 230.

The insulating layer 231 may be formed by an appropriate method, and may be formed, for example, by pressing an insulating resin into an uncured film form using a laminator and then curing the uncured film. Alternatively, the insulating layer 231 may also be formed by applying an insulating material using an appropriate method such as a spin method and then curing the insulating material.

Next, an opening may be formed in the insulating layer 231. The opening may be formed by using an appropriate photo lithography method, and for example, the opening may be patterned by exposing an appropriate photomask to a desired pattern and then developing the exposed photomask. The opening may be formed in the shape of a coil pattern, a shape of a double coil pattern (e.g., a double coil pattern in which two coils are interlaced), or the like.

Next, first seed layers 21 and 22 may be formed on a top surface of the insulating layer 231, and a portion of a side surface and a portion of a bottom surface of an interior of the opening in the insulating layer 231.

As described above, the first seed layers 21 and 22 may be a multilayer structure. In this case, a buffer seed layer 21 may first be formed, and a plating seed layer 22 may be formed on the buffer seed layer 21.

A method of forming the first seed layers 21 and 22 is not particularly limited, and any appropriate method may be used , for example, a method capable of forming the seed layers in a thin film form such as a sputtering method, a spin method, chemical copper, or the like.

Further, the first seed layers 21 and 22 may form the buffer seed layer 21 including titanium (Ti) and the plating seed layer 22 including copper on the buffer seed layer 21.

Referring to FIG. 4B, a second seed layer 23 may be formed on the first seed layers 21 and 22.

A method of forming the second seed layer 23 is not particularly limited, and may be formed by entire surface plating using an appropriate method based on the first seed layers 21 and 22, for example, an electroless plating method, or the like.

That is, the second seed layer 23 may be formed to cover upper portions of the first seed layers 21 and 22, and may be formed to cover the entirety of the side surface and the bottom surface of the interior of the opening.

Referring to FIG. 4C, a metal layer 24 may be formed on the second seed layer 23.

A method of forming the method layer 24 is not particularly limited, and may be formed by plating an entire surface using an appropriate method based on the second seed layer 23, for example, an electroplating method, or the like.

That is, the metal layer 24 may be formed to cover an upper portion of the second seed layer 23.

Referring to FIG. 4D, a top surface of the insulating layer 231 on which the first seed layers 21 and 22, the second seed layer 23, and the metal layer 24 are formed may be flattened.

As a result of the flattening, top surfaces of the first seed layers 21 and 22, the second seed layer 23, and the metal layer 24 may be substantially on the same plane as the top surface of the insulating layer 231.

In addition, the top surface of the metal layer 24 may be substantially on the same plane as open surfaces of the first seed layers 21 and 22 and the second seed layer 23.

A flattening method is not particularly limited, and an appropriate method, for example chemical mechanical polishing (CMP), lapping grinding, and the like may be used.

Although in the drawings it is illustrated that only two coil patterns 210 and 220 and one substrate 230 are formed for convenience of explanation, layers of the two or more coil patterns and one or more substrates may be formed according to desired capacity.

Next, a first cover part 100a and a second cover part 100b may be formed on an upper portion and a lower portion of the coil part 200. The first and second cover parts 100a and 100b may be formed, for example, by a method in which sheet-type first and second magnetic materials are respectively pressed and stacked on the upper portion and the lower portion of the coil part 200.

Next, external electrodes 301a, 301b, 302a, and 302b of which at least a portion is disposed on the first cover part 100a and the second cover part 100b may be formed. A method of forming the external electrodes 301a, 301b, 302a, and 302b is also not particularly limited, and any appropriate method such as a printing method, a dipping method, or the like may be used.

Although in the drawings it is illustrated that one coil component 10 is manufactured for convenience of explanation, the coil components 10 may be manufactured in a practical production process by a method in which a plurality of coil components are simultaneously formed on one large substrate and are then separately cut.

Meanwhile, in the present specification, a word “electrically connected” is a concept including both of a case in which any component is electrically connected through a direct physical connection to another component and a case in which a component is electrically connected but not necessarily through a direct physical connection to the other component.

Meanwhile, a term “example” used in the present disclosure does not mean the same example, but is provided in order to emphasize and describe different unique features. However, one suggested example may be implemented to be combined with a feature of another example. For example, even though particulars described in a specific example are not described in another example, it may be understood that such particulars can be incorporated in the other example unless described otherwise.

In addition, terms used in the present disclosure are used only in order to describe an example rather than limit the scope of the present disclosure.

As set forth above, according to the exemplary embodiments, since the insulating layer and the pattern may be simultaneously formed, productivity may be excellent, and the coil loss factor may be decreased to thereby secure low resistance.

Further, since a high aspect ratio (A/R) is implemented, chip performance may be improved, and even though an existing facility is used, the uniform seed layer may be implemented in the opening of the insulating layer.

While exemplary embodiments have been shown and described above, it will be apparent to those skilled in the art that modifications and variations could be made without departing from the scope of the present invention as defined by the appended claims.

What is claimed is:

1. A coil component comprising:
a substrate; and
a coil part disposed on the substrate,
wherein the coil part includes an insulating layer having an opening, and one or more coil patterns disposed in the opening, and
the one or more coil patterns include first seed layers disposed on a portion of a side surface and a portion of a bottom surface of an interior of the opening, a second seed layer disposed to cover the first seed layers, and a metal layer disposed on the second seed layer.

2. The coil component of claim 1, wherein the first seed layers include a plurality of layers overlapping each other.

3. The coil component of claim 2, wherein the first seed layers are configured of a first layer including one or more of titanium (Ti), molybdenum (Mo), tungsten (W), and tantalum (Ta), and a second layer including copper (Cu) disposed on the first layer including one or more of titanium (Ti), molybdenum (Mo), tungsten (W), and tantalum (Ta).

4. The coil component of claim 1, wherein the one or more coil patterns each include three or more layers each including copper.

5. The coil component of claim 1, wherein the first seed layers include a first layer and a second layer disposed to cover an entirety of the first layer.

6. The coil component of claim 1, wherein the second seed layer is disposed to cover an entirety of the side surface and the bottom surface of the interior of the opening.

7. The coil component of claim 1, wherein the metal layer includes copper.

8. A coil component comprising:
a substrate; and
a coil part disposed on the substrate,
wherein the coil part includes an insulating layer having an opening and one or more coil patterns disposed in the opening, and
three or more layers each including copper are disposed on a portion of a side surface and a portion of a bottom surface of an interior of the opening.

9. The coil component of claim 8, wherein an electroless plating layer is disposed on the side surface and the bottom surface of the interior of the opening, and an electroplating layer is disposed on the electroless plating layer.

10. The coil component of claim 9, wherein the electroless plating layer includes copper (Cu).

11. The coil component of claim 8, wherein the one or more coil patterns each include a first seed layer disposed on the portion of the side surface and the portion of the bottom surface of the interior of the opening, a second seed layer disposed to cover the first seed layer, and a metal layer disposed on the second seed layer.

12. The coil component of claim 11, wherein each first seed layer includes a plurality of layers.

13. The coil component of claim 11, wherein each first seed layer includes a first layer including one or more of titanium (Ti), molybdenum (Mo), tungsten (W), and tantalum (Ta), and a second layer including copper (Cu) disposed on the first layer including one or more of titanium (Ti), molybdenum (Mo), tungsten (W), and tantalum (Ta).

14. The coil component of claim 8, wherein different numbers of layers each including copper are disposed in different regions of an exposed part of the substrate exposed in the opening.

15. A method comprising:
forming an opening in an insulating layer disposed on a substrate, wherein the opening is formed in a pattern of one or more coils; and
forming a coil part including one or more coil patterns in the opening formed in the insulating layer,
wherein the forming of the coil part includes forming first seed layers on a portion of a side surface and a portion of a bottom surface of an interior of the opening, forming a second seed layer to cover the first seed layers, and forming a metal layer on the second seed layer.

16. The method of claim 15, wherein the forming of the second seed layer comprises forming the second seed layer by electroless plating on the first seed layer.

17. The method of claim 16, wherein the forming of the metal layer comprises forming the metal layer by electroplating on the second seed layer.

18. The method of claim 17, wherein the forming of the first seed layers comprises:
forming a buffer seed layer on the portion of the side surface and the portion of the bottom surface of the interior of the opening; and
forming a plating seed layer to cover the buffer seed layer.

19. The method of claim 15, wherein the forming of the opening comprises forming openings in insulating layers disposed on two opposing surfaces of the substrate, each opening being formed in the pattern of one or more coils,
the forming the coil part comprises forming coil parts including one or more coil patterns in each opening formed in the insulating layers disposed on the two opposing surfaces of the substrate, and
the method further comprises forming at least one conductive via extending through the substrate to electrically interconnect coils parts formed on the two opposing surfaces of the substrate.
